(19) United States
(12) Patent Application Publication
(10) Pub. No.: US 2006/0168407 A1
(43) Pub. Date: Jul. 27, 2006

(54) Memory hub system and method having large virtual page size

(75) Inventor: Bryan Alan Stern, Chisago City, MN (US)

Correspondence Address: Edward W. Bulchis, Esq.;DORSEY & WHITNEY LLP, Suite 3400, 1420 Fifth Avenue, Seattle, WA, 98101, US

(73) Assignee: Micron Technology, Inc.

(21) Appl. No.: 11/044,919

(22) Filed: Jan. 26, 2005

(51) Int. Cl. G06F 13/00

(52) U.S. Cl. 711/154

(57) ABSTRACT

A memory system and method includes a memory hub controller coupled to a plurality of memory modules through a high-speed link. Each of the memory modules includes a memory hub coupled to a plurality of memory devices. The memory hub controller issues a command to open a page in a memory device in one memory module at the same time that a page is open in a memory device in another memory module. In addition to opening pages of memory devices in two or more memory modules, the pages that are simultaneously open may be in different ranks of memory devices in the same memory module and/or in different banks of memory cells in the same memory device. As a result, the memory system is able to provide an virtual page having a very large effective size.

### TECHNICAL FIELD

This invention relates to computer systems, and, more particularly, to a computer system having a memory hub coupling several memory devices to a processor or other memory access device.

### BACKGROUND OF THE INVENTION

Computer systems use memory devices, such as dynamic random access memory (“DRAM”) devices, to store data that are accessed by a processor. These memory devices are normally used as system memory in a computer system. In a typical computer system, the processor communicates with the system memory through a processor bus and a memory controller. The processor issues a memory request, which includes a memory command, such as a read command, and an address designating the location from which data or instructions are to be read. The memory controller uses the command and address to generate appropriate command signals as well as row and column addresses, which are applied to the system memory. In response to the commands and addresses, data are transferred between the system memory and the processor. The memory controller is often part of a system controller, which also includes bus bridge circuitry for coupling the processor bus to an expansion bus, such as a PCI bus.

Although the operating speed of memory devices has continuously increased, this increase in operating speed has not kept pace with increases in the operating speed of processors. Even slower has been the increase in operating speed of memory controllers coupling processors to memory devices. The relatively slow speed of memory controllers and memory devices limits the data bandwidth between the processor and the memory devices.

In addition to the limited bandwidth between processors and memory devices, the performance of computer systems is also limited by latency problems that increase the time required to read data from system memory devices. More specifically, when a memory device read command is coupled to a system memory device, such as a synchronous DRAM (“SDRAM”) device, the read data are output from the SDRAM device only after a delay of several clock periods. Therefore, although SDRAM devices can synchronously output burst data at a high data rate, the delay in initially providing the data can significantly slow the operating speed of a computer system using such SDRAM devices.

An important factor in the limited bandwidth and latency problems in conventional SDRAM devices results from the manner in which data are accessed in an SDRAM device. To access data in an SDRAM device, a page of data corresponding to a row of memory cells in an array is first opened. To open the page, it is necessary to first equilibrate or precharge the digit lines in the array, which can require a considerable period of time. Once the digit lines have been equilibrated, a word line for one of the rows of memory cells can be activated, which results in all of the memory cells in the activated row being coupled to a digit line in a respective column. Once sense amplifiers for respective columns have sensed logic levels in respective columns, the memory cells in all of the columns for the active row can be quickly accessed.

Fortunately, memory cells are frequently accessed in sequential order so that memory cells in an active page can be accessed very quickly. Unfortunately, once all of the memory cells in the active page have been accessed, it can require a substantial period of time to access memory cells in a subsequent page. The time required to open a new page of memory can greatly reduce the bandwidth of a memory system and greatly increase the latency in initially accessing memory cells in the new page.

Attempts have been made to minimize the limitations resulting from the time required to open a new page. One approach involves the use of page caching algorithms that boost memory performance by simultaneously opening several pages in respective banks of memory cells. Although this approach can increase memory bandwidth and reduce latency, the relatively few number of banks typically used in each memory device limits the number of pages that can be simultaneously open. As a result, the performance of memory devices is still limited by delays incurred in opening new pages of memory.

Another approach that has been proposed to minimize bandwidth and latency penalties resulting from the need to open new pages of memory is to simultaneously open pages in each of several different memory devices. However, this technique creates the potential problem of data collisions resulting from accessing one memory device when data are still being coupled to or from a previously accessed memory device. Avoiding this problem generally requires a one clock period delay between accessing a page in one memory device and subsequently accessing a page in the another memory device. This one clock period delay penalty can significantly limit the bandwidth of memory systems employing this approach.

One technique for alleviating memory bandwidth and latency problems is to use multiple memory devices coupled to the processor through a memory hub. In a memory hub architecture, a memory controller is coupled to several memory modules, each of which includes a memory hub coupled to several memory devices, such as SDRAM devices. The memory hub efficiently routes memory requests and responses between the controller and the memory devices. Computer systems employing this architecture can have a higher bandwidth because a processor can access one memory device while another memory device is responding to a prior memory access. For example, the processor can output write data to one of the memory devices in the system while another memory device in the system is preparing to provide read data to the processor.

Although computer systems using memory hubs may provide superior performance, they nevertheless often fail to operate at optimum speed for several reasons. For example, even though memory hubs can provide computer systems with a greater memory bandwidth, they still suffer from bandwidth and latency problems of the type described above. More specifically, although the processor may communicate with one memory module while the memory hub in another memory module is accessing memory devices in that module, the memory cells in those memory devices can only be accessed in an open page. When all of the memory cells in the open page have been accessed, it is still necessary for the memory hub to wait until a new page has been opened before additional memory cells can be accessed.

There is therefore a need for a method and system for accessing memory devices in each of several memory modules in a manner that minimizes memory bandwidth and latency problems resulting from the need to open a new page when all of the memory cells in an open page have been accessed.

### SUMMARY OF THE INVENTION

A memory system and method includes a memory hub controller coupled to a first and second memory modules each of which includes a plurality of memory devices. The memory hub controller opens a page in at least one of the memory devices in the first memory module. The memory hub controller then opens a page in at least one of the memory devices in the second memory module while the page in at least one of the memory devices in the first memory module remains open. The open pages in the memory devices in the first and second memory modules are then accessed in write or read operations. The pages that are simultaneously open preferably correspond to the same row address. The simultaneously open pages may be in different ranks of memory devices in the same memory module and/or in different banks of memory cells in the same memory device.

### BRIEF DESCRIPTION OF THE DRAWINGS

FIG. 1 is a block diagram of a computer system according to one example of the invention in which a memory hub is included in each of a plurality of memory modules.

FIG. 2 is a block diagram of a memory hub used in the computer system of FIG. 1.

FIG. 3 is a table showing the manner in which pages of memory devices in different memory modules can be simultaneously opened in the computer system of FIG. 1.

FIG. 4 is a table showing the manner in which the memory hub controller used in the computer system of FIG. 1 can remap processor address bits to simultaneously open pages in different banks of different memory devices in different ranks and in different memory modules.

### DETAILED DESCRIPTION

A computer system 100 according to one embodiment of the invention uses a memory hub architecture that includes a processor 104 for performing various computing functions, such as executing specific software to perform specific calculations or tasks. The processor 104 includes a processor bus 106 that normally includes an address bus, a control bus, and a data bus. The processor bus 106 is typically coupled to cache memory 108, which, is typically static random access memory (“SRAM”). Finally, the processor bus 106 is coupled to a system controller 110, which is also sometimes referred to as a bus bridge.

The system controller 110 contains a memory hub controller 112 that is coupled to the processor 104. The memory hub controller 112 is also coupled to several memory modules 114a-n through an upstream bus 115 and a downstream bus 117. The downstream bus 117 couples commands, addresses and write data away from the memory hub controller 112. The upstream bus 115 couples read data toward the memory hub controller 112. The downstream bus 117 may include separate command, address and data buses, or a smaller number of busses that couple command, address and write data to the memory modules 114a-n. For example, the downstream bus 117 may be a single multi-bit bus through which packets containing memory commands, addresses and write data are coupled. The upstream bus 115 may be simply a read data bus, or it may be one or more buses that couple read data and possibly other information from the memory modules 114a-n to the memory hub controller 112. For example, read data may be coupled to the memory hub controller 112 along with data identifying the memory request corresponding to the read data.

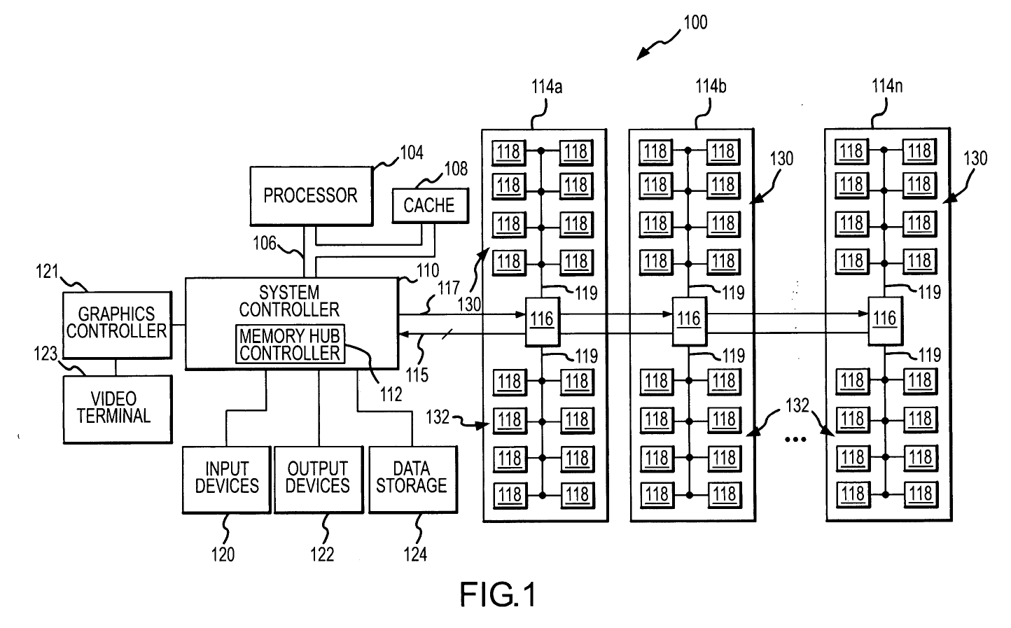

Each of the memory modules 114a-n includes a memory hub 116 for controlling access to 16 memory devices 118, which, in the example illustrated in FIG. 1, are synchronous dynamic random access memory (“SDRAM”) devices. However, a fewer or greater number of memory devices 118 may be used, and memory devices other than SDRAM devices may, of course, also be used. As explained in greater detail below, the memory hub 116 in all but the final memory module 114n also acts as a conduit for coupling memory commands to downstream memory hubs 116 and data to and from downstream memory hubs 116. The memory hub 116 is coupled to each of the system memory devices 118 through a bus system 119, which normally includes a control bus, an address bus and a data bus. According to one embodiment of the invention, the memory devices 118 in each of the memory modules 114a-n are divided into two ranks 130, 132, each of which includes eight memory devices 118. As is well known to one skilled in the art, all of the memory devices 118 in the same rank 130, 132 are normally accessed at the same time with a common memory command and common row and column addresses. In the embodiment shown in FIG. 1, each of the memory devices 118 in the memory modules 114a-n includes four banks of memory cells each of which can have a page open at the same time a page is open in the other three banks. However, it should be understood that a greater or lesser number of banks of memory cells may be present in the memory devices 118, each of which can have a page open at the same time.

In addition to serving as a communications path between the processor 104 and the memory modules 114a-n, the system controller 110 also serves as a communications path to the processor 104 for a variety of other components. More specifically, the system controller 110 includes a graphics port that is typically coupled to a graphics controller 121, which is, in turn, coupled to a video terminal 123. The system controller 110 is also coupled to one or more input devices 120, such as a keyboard or a mouse, to allow an operator to interface with the computer system 100. Typically, the computer system 100 also includes one or more output devices 122, such as a printer, coupled to the processor 104 through the system controller 110. One or more data storage devices 124 are also typically coupled to the processor 104 through the system controller 110 to allow the processor 104 to store data or retrieve data from internal or external storage media (not shown). Examples of typical storage devices 124 include hard and floppy disks, tape cassettes, and compact disk read-only memories (CD-ROMs).

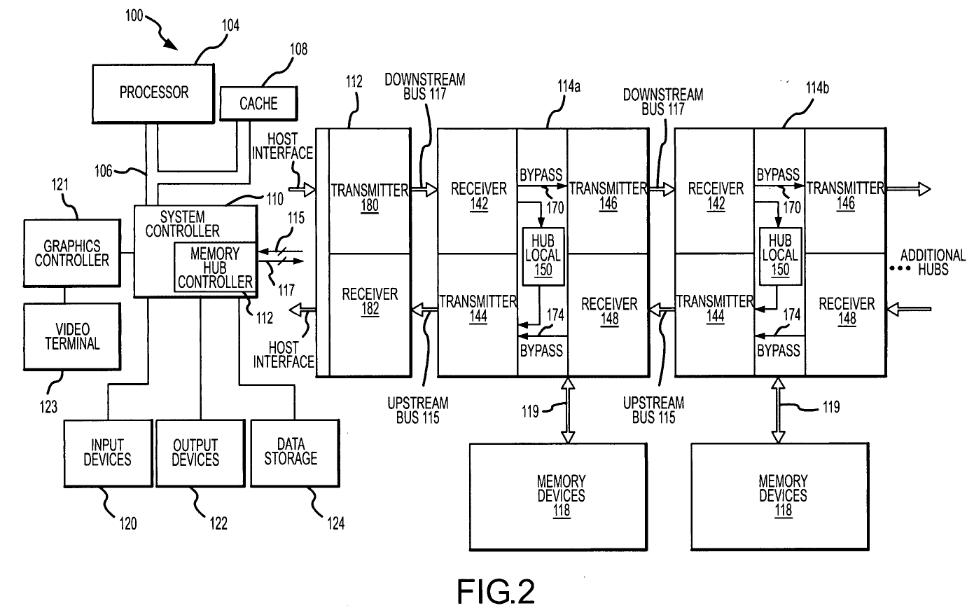

The internal structure of one embodiment of the memory hubs 116 is shown in greater detail in FIG. 2 along with the other components of the computer system 100 shown in FIG. 1. Each of the memory hubs 116 includes a first receiver 142 that receives memory requests (e.g., memory commands, memory addresses and, in some cases, write data) through the downstream bus system 117, a first transmitter 144 that transmits memory responses (e.g., read data and, in some cases, responses or acknowledgments to memory requests) upstream through the upstream bus 115, a second transmitter 146 that transmits memory requests downstream through the downstream bus 117, and a second receiver 148 that receives memory responses through the upstream bus 115.

The memory hubs 116 also each include a memory hub local 150 that is coupled to its first receiver 142 and its first transmitter 144. The memory hub local 150 receives memory requests through the downstream bus 117 and the first receiver 142. If the memory request is received by a memory hub that is directed to a memory device in its own memory module 114 (known as a “local request”), the memory hub local 150 couples a memory request to one or more of the memory devices 118. The memory hub local 150 also receives read data from one or more of the memory devices 118 and couples the read data through the first transmitter 144 and the upstream bus 115.

In the event the write data coupled through the downstream bus 117 and the first receiver 142 is not being directed to the memory devices 118 in the memory module 114 receiving the write data, the write data are coupled though a downstream bypass path 170 to the second transmitter 146 for coupling through the downstream bus 117. Similarly, if read data is being transmitted from a downstream memory module 114, the read data is coupled through the upstream bus 115 and the second receiver 148. The read data are then coupled upstream through an upstream bypass path 174, and then through the first transmitter 144 and the upstream bus 115. The second receiver 148 and the second transmitter 146 in the memory module 114n furthest downstream from the memory hub controller 112 are not used and may be omitted from the memory module 114n.

As further shown in FIG. 2, the memory hub controller 112 also includes a transmitter 180 coupled to the downstream bus 117, and a receiver 182 coupled to the upstream bus 115. The downstream bus 117 from the transmitter 180 and the upstream bus 115 to the receiver 182 are coupled only to the memory module 114a that is the furthest upstream to the memory hub controller 112. The transmitter 180 couples write data from the memory hub controller 112, and the receiver 182 couples read data to the memory hub controller 112.

The memory hub controller 112 need not wait for a response to the memory command before issuing a command to either another memory module 114a-n or another rank 130, 132 in the previously accessed memory module 114a-n. After a memory command has been executed, the memory hub 116 in the memory module 114a-n that executed the command may send an acknowledgment to the memory hub controller 112, which, in the case of a read command, may include read data. As a result, the memory hub controller 112 need not keep track of the execution of memory commands in each of the memory modules 114a-n. The memory hub architecture is therefore able to process memory requests with relatively little assistance from the memory hub controller 112 and the processor 104. Furthermore, computer systems employing a memory hub architecture can have a higher bandwidth because the processor 104 can access one memory module 114a-n while another memory module 114a-n is responding to a prior memory access. For example, the processor 104 can output write data to one of the memory modules 114a-n in the system while another memory module 114a-n in the system is preparing to provide read data to the processor 104. However, as previously explained, this memory hub architecture does not solve the bandwidth and latency problems resulting from the need for a page of memory cells in one of the memory devices 118 to be opened when all of the memory cells in an open row have been accessed.

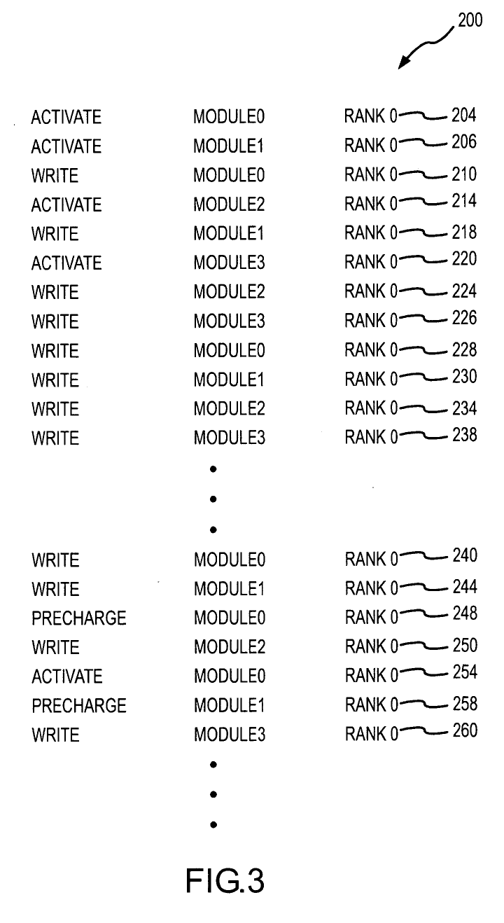

In one embodiment of the invention, the memory hub controller 112 accesses the memory devices 118 in each of the memory modules 114a-n according to a process 200 that will be described with reference to the flow-chart of FIG. 3. Basically, the process simultaneously opens a page in more than one of the memory devices 118 so that memory accesses to a page appear to the memory hub controller 112 to be substantially larger than a page in a single one of the memory devices 118. The apparent size of the page can be increased by simultaneously opening pages in several different memory modules, in both ranks of the memory devices in each of the memory modules, and/or in several banks of the memory devices. In the process 200 shown in FIG. 3, an activate command and a row address is coupled to the first rank 130 of memory devices 118 in the first memory module 114a at step 204 to activate a page in the memory devices 118 in the first rank 130. In step 206, the first rank 130 of memory devices 118 in the second memory module 114b are similarly activated to open the same page in the memory devices 118 in the second memory module 114b that is open in the first memory module 114a. As previously explained, this process can be accomplished by the memory hub controller 112 transmitting the memory request on the downstream bus system 117. The memory hub 140 in the first memory module 114a receives the request, and, recognizing that the request is not a local request, passes it onto the next memory module 114b through the downstream bus system 117. In step 210, a write command and the address of the previously opened row are applied to the memory devices 118 in the first memory module 114a that were opened in step 204. Data may be written to these memory devices 118 pursuant to the write command in a variety of conventional processes. For example, column address for the open page may be generated internally by a burst counter. In step 214, still another page of memory is opened, this one in the memory devices 118 in the first rank of a third memory module 114c. In the next step 218, data are written to the page that was opened in step 206. In step 220, a fourth page is opened by issuing an activate command to the first rank 130 of the memory devices 118 in the fourth memory module 114d. In step 224, data are then written to the page that was opened in step 218, and, in step 226, data are written to the page that was opened in step 220. At this point data have been written to 4 pages of memory, and writing to these open pages continues in steps 228, 230, 234, 238. The page to which data can be written appears to the memory hub controller 112 to be a very large page, i.e., four times the size of the page of a single one of the memory devices 118. As a result, data can be stored at a very rapid rate since there is no need to wait while a page of memory in one of the memory devices 118 is being precharged after data has been stored corresponding to one page in the memory devices 118.

With further reference to FIG. 3, after data has been written to the first rank 130 of memory devices 118 in the first memory module 114a in step 240, the open page in those memory devices has been filled. Similarly, the open page in the first rank 130 of the memory devices 118 in the second memory module 114b is filled in step 244. The memory hub controller 112 therefore issues a precharge command in step 248, which is directed to the first rank 130 of memory devices 118 in the first memory module 114a. However, the memory hub controller 112 need not wait for the precharge to be completed before issuing another write command. Instead, it immediately issues another write command in step 250, which is directed to the memory devices 118 in the third memory module 114c. This last write to the memory module 114c in step 250 fills the open page in the third memory module 114c.

By the time the write memory request in step 250 has been completed, the precharge of the first rank 130 of memory devices 118 in the first memory module 114a, which was initiated at step 248, has been competed. The memory hub controller 112 therefore issues an activate command to those memory devices 118 at step 254 along with an address of the next page to be opened. The memory hub controller 112 also issues a precharge command at step 258 for the memory devices 118 in the third memory module 114c. However, the memory hub controller 112 need not wait for the activate command issued in step 254 and the precharge command issued in step 258 to be executed before issuing another memory command. Instead, in step 260, the memory hub controller 112 can immediately issue a write command to the first rank 130 of memory devices 118 in the fourth memory module 114d. This write command can be executed in the memory module 114d during the same time that the activate command issued in step 254 is executed in the first memory module 114a and the precharge command issued in step 258 is executed in the third memory module 114c.

The previously described steps are repeated until all of the data that are to be written to the memory modules 114 have been written. The data can be written substantially faster than in conventional memory devices because of the very large effective size of the open page to which the data are written, and because memory commands can be issued to the memory modules 114 without regard to whether or not execution of the prior memory command has been completed.

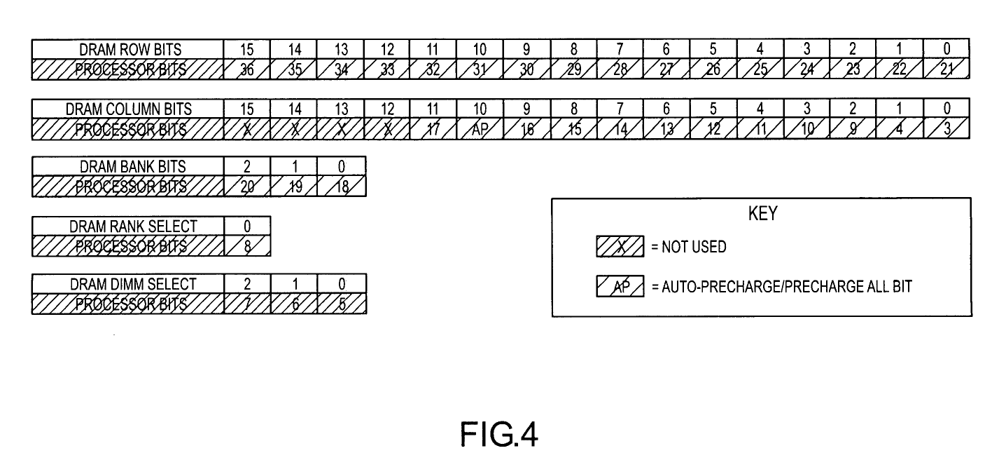

In the example explained with reference to FIG. 3, data are written to only one bank of each of the memory devices 118 and only the first rank 130 of those memory devices 118. The effective size of the open page could be further increased by simultaneously opening a page in each of the banks of the memory devices 118 in both the first rank 130 and the second rank 132. For example, FIG. 4 shows the manner in which the memory hub controller 112 can remap the address bits of the processor 104 (FIG. 1) to address bits of the memory modules 114. The processor bits 0-2 are not used because data are addressed in the memory modules 114 in 8-bit bytes, this making it unnecessary to differentiate within each byte using processor address bits 0-2.

As shown in FIG. 4, it is assumed that the processor bits sequentially increment. Processor address bits 5-7 are used to select between eight memory modules 114, and processor bit 8 is used to select between two ranks in each of those memory modules 114. Processor bits 3-17 are used to select a column in an open page. More particularly, bits 3 and 4 are used to select respective columns in a burst of 4 operating mode. After that page has been filled, processor bits 18-20 are used to open a page in the next bank of memory cells in the memory devices 118. However, as explained above, while that page is being opened, a page of memory cells in a different rank and bank are accessed because less significant bits are used to address the ranks and banks. Finally, processor bits 21-36 are used to select each page, i.e., row, of memory cells in each of the memory devices 118.

It will also be noted that memory device bit 10 is mapped to a bit designated “AP.” This bit is provided by the memory hub controller 112 rather than by the processor 104. When set, the memory device bit 10 causes an open page of the memory device 118 being addressed to close out the page by precharging the page after a read or a write access has occurred. Therefore, when the memory hub controller 112 accesses the last columns in an open page, it can set bit 10 high to initiate a precharge in that memory device 118.

Although the present invention has been described with reference to the disclosed embodiments, persons skilled in the art will recognize that changes may be made in form and detail without departing from the spirit and scope of the invention. Such modifications are well within the skill of those ordinarily skilled in the art. Accordingly, the invention is not limited except as by the appended claims.

We claim:

1. A memory system, comprising:
a plurality of memory modules, each of the memory modules including a memory hub coupled to a plurality of memory devices; and
a memory hub controller coupled to the memory hub in each of the memory modules through a high-speed link, the memory hub controller being operable to issue a command to one of the memory modules to open a page in one of the memory devices in the memory module at the same time that a page is open in one of the memory devices in another one of the memory modules.

2. The memory system of claim 1 wherein the memory devices in each of the memory modules are divided into at least two ranks, and wherein the memory hub controller is operable to issue a command to a memory hub to open a page in one rank of the memory devices at the same time that a page is open in another rank of the memory devices in the same memory module.

3. The memory system of claim 1 wherein the memory devices in each of the memory modules include a plurality of banks of memory cells, and wherein the memory hub controller is operable to issue a command to a memory hub to open a page in one of the banks of memory cells at the same time that a page is open in another rank of the memory devices in the same memory module.

4. The memory system of claim 1 wherein the memory hub controller is operable to provide an address corresponding to a first row address with the command to open a page in one of the memory devices, and wherein the memory hub controller is operable to provide an address corresponding to a second row address when providing the command to open a page in the other one of the memory modules.

5. The memory system of claim 4 wherein the first row address is identical to the second row address.

6. The memory system of claim 1 wherein the high-speed link comprises a high-speed downlink coupling the commands from the memory hub controller to the memory modules and a high-speed uplink coupling read data from the memory modules to the memory hub controller.

7. The memory system of claim 1 wherein the memory hub in at least some of the memory modules comprises:
a first receiver coupled to a portion of the downlink extending from the memory hub controller;
a first transmitter coupled to a portion of the uplink extending to the memory hub controller;
a second receiver coupled to a portion of the uplink extending from a downstream memory module;
a second transmitter coupled to a portion of the downlink extending toward the downstream memory module;
a memory hub local coupled to the first receiver, the first transmitter, and the memory devices in the memory module,
a downstream bypass link coupling the first receiver to the second transmitter; and
an upstream link coupling the second receiver to the first transmitter.

8. The memory system of claim 1 wherein the memory devices in each of the memory modules comprise dynamic random access memory devices.

9. A processor-based system, comprising
a processor having a processor bus;
an input device coupled to the processor through the processor bus adapted to allow data to be entered into the computer system;
an output device coupled to the processor through the processor bus adapted to allow data to be output from the computer system;
a plurality of memory modules, each of the memory modules including a memory hub coupled to a plurality of memory devices; and
a memory hub controller coupled to the processor through the processor bus and to the memory hub in each of the memory modules through a high-speed link, the memory hub controller being operable to issue a command to one of the memory modules to open a page in one of the memory devices in the memory module at the same time that a page is open in one of the memory devices in another one of the memory modules.

10. The processor-based system of claim 9 wherein the memory devices in each of the memory modules are divided into at least two ranks, and wherein the memory hub controller is operable to issue a command to a memory hub to open a page in one rank of the memory devices at the same time that a page is open in another rank of the memory devices in the same memory module.

11. The processor-based system of claim 9 wherein the memory devices in each of the memory modules include a plurality of banks of memory cells, and wherein the memory hub controller is operable to issue a command to a memory hub to open a page in one of the banks of memory cells at the same time that a page is open in another rank of the memory devices in the same memory module.

12. The processor-based system of claim 9 wherein the memory hub controller is operable to provide an address corresponding to a first row address with the command to open a page in one of the memory devices, and wherein the memory hub controller is operable to provide an address corresponding to a second row address when providing the command to open a page in the other one of the memory modules.

13. The processor-based system of claim 12 wherein the first row address is identical to the second row address.

14. The processor-based system of claim 9 wherein the high-speed link comprises a high-speed downlink coupling the commands from the memory hub controller to the memory modules and a high-speed uplink coupling read data from the memory modules to the memory hub controller.

15. The processor-based system of claim 9 wherein the memory hub in at least some of the memory modules comprises:
a first receiver coupled to a portion of the downlink extending from the memory hub controller;
a first transmitter coupled to a portion of the uplink extending to the memory hub controller;
a second receiver coupled to a portion of the uplink extending from a downstream memory module;
a second transmitter coupled to a portion of the downlink extending toward the downstream memory module;
a memory hub local coupled to the first receiver, the first transmitter, and the memory devices in the memory module,
a downstream bypass link coupling the first receiver to the second transmitter; and
an upstream link coupling the second receiver to the first transmitter.

16. The processor-based system of claim 9 wherein the memory devices in each of the memory modules comprise dynamic random access memory devices.

17. In a memory system having memory hub controller coupled to a first and second memory modules each of which includes a plurality of memory devices, a method of accessing the memory devices in the memory modules, comprising:
opening a page in at least one of the memory devices in the first memory module;
opening a page in at least one of the memory devices in the second memory module while the page in the at least one of the memory devices in the first memory module remains open; and
accessing the open pages in the memory devices in the first and second memory modules.

18. The method of claim 17 wherein the acts of opening a page in at least one of the memory devices in the first memory module and opening a page in at least one of the memory devices in the second memory module comprise activating a row of memory cells in the at least one of the memory devices in the first and second memory modules.

19. The method of claim 17 wherein the act of opening a page in at least one of the memory devices in the first memory module comprise opening a page in a first bank of the at least one of the memory devices while a page in a second bank of the at least one of the memory devices is open.

20. The method of claim 17 wherein the memory devices in the first memory module are divided into first and second ranks, and wherein the act of opening a page in at least one of the memory devices in the first memory module comprise opening a page in at least one of the memory devices in the first rank while a page in at least one of the memory devices in the second rank is open.

21. The method of claim 17 wherein the act of accessing the open pages in the memory devices in the first and second memory modules comprises accessing the open page in the memory devices in the first memory module while a new page in at least one of the memory devices in the second memory module is being opened.

22. The method of claim 17 wherein the act of accessing the open pages in the memory devices in the first and second memory modules comprises accessing the open page in the memory devices in the first memory module while a new page in at least one of the memory devices in the second memory module is being precharged.

23. The method of claim 17 wherein the acts of opening a page in at least one of the memory devices in the first memory module and opening a page in at least one of the memory devices in the second memory module comprise opening a page in a memory device in the second memory module having the same row addresses as the page that is opened in the memory device in the first memory module.
